(19) United States
(12) Patent Application Publication
(10) Pub. No.: US 2019/0325642 A1
(43) Pub. Date: Oct. 24, 2019

(54) COMPUTER PLATFORM FOR POOLING AND VIEWING DIGITAL DATA

(71) Applicant: SOLETANCHE FREYSSINET, Rueil-Malmaison (FR)

(72) Inventor: Jacques MARTINET, Igny (FR)

(73) Assignee: SOLETANCHE FREYSSINET, Rueil-Malmaison (FR)

(21) Appl. No.: 16/388,065

(22) Filed: Apr. 18, 2019

(30) Foreign Application Priority Data
Apr. 19, 2018 (FR) 18 53443

(51) Int. Cl. G06T 17/05; G06T 19/00; G06F 16/909; G06K 9/00; G06F 17/50; G06F 16/901; G06F 16/9032

(52) U.S. Cl. CPC G06T 17/05; G06T 19/006; G06F 16/909; G06F 9/541; G06F 17/50; G06F 16/9024; G06F 16/90328; G06K 9/0063

(57) ABSTRACT

Computer platform for pooling and viewing digital data on a planet or sub-planet scale, which platform lists georeferenced data used for the representation of heterogeneous objects originating from various sources, including objects derived from scans and objects derived from at least one computer assisted drawing software package, metadata logged in at least one database being associated with at least some of the georeferenced data, these metadata comprising at least one item of information relating to the accuracy with which the position of these georeferenced data in at least one frame of reference is known.

The present invention relates to the creation of works, notably of buildings or infrastructures underground or on the surface, and to the means made available to those working in that sector in order to assist them in their work.

### BACKGROUND

When works such as excavations are to be performed near underground networks, it is common practice to require administrative authorization (in France a DT-DICT) or Permit to dig from the relevant town planning departments. These departments question a certain number of companies or organizations so that these can state whether pipes or other buried elements are present in the zone concerned and, if so, discover their position.

In practice, these approaches take time and the accuracy of the information regarding the location of the underground networks is sometimes very approximative, leading to a risk during digging. In order to reduce this risk, preliminary surveys are conducted or bore holes sunk, although this adds to the cost and slows down the site work.

On-line sites such as that of the French National Geographic Institute IGN or the BRGM, which make it possible to view maps relating to the occupancy of the ground or the geological nature of the subsoil are known. However, the maps produced do not cover the detail of the existing infrastructures and as far as the geology is concerned do not give information with the required degree of accuracy for carrying out work.

Patent U.S. Pat. No. 8,799,799 describes an interactive map although this is not intended to assist with performing work in the subsoil.

Urban scale models proposed to the CityGML standard exist. However, such models do not tackle the sets of problems concerned with identifying underground networks.

There are also 3D models for computer aided earthworks, in which the driver of an earth mover is guided by his onboard computer which compares the position of the earth mover with that of the 3D model of the earthworks to be performed in order to provide suitable instructions.

The works “BIM & BTP [BIM & building and public works]” by Méthodes BTP Publishing, 2017, proposes integrating the position of each network into a digital urban model, something which would allow the proximity of a network to be indicated to the driver of an earth mover. However, as the author emphasizes, the problem stems essentially from the lack of reliability of the sets of record drawings encountered in practice, which is something such a model alone is unable to solve.

There is therefore still a need to reduce the risk of damage to pipes or other elements buried in the ground when performing excavation work.

There are numerous other situations in which accurate knowledge of the state of the subsoil would make it possible to reduce the cost and duration of site work.

There is therefore a need to facilitate the creation of works or intervention on sites on which buried networks are potentially present.

More generally, there still remains a need to improve the exchanges and sharing of data between construction professionals, and to make the data relating to the works constructed and interventions performed more reliable.

There is also some benefit in creating novel tools to predict how works evolve on the basis of various factors, notably the aging thereof, and facilitate the maintenance or exploitation thereof.

### SUMMARY

The invention seeks to meet all or some of these objectives, and achieves this by virtue of a computer platform for pooling and viewing digital data on a planet or sub-planet scale, which platform lists georeferenced data used for the representation of heterogeneous objects originating from various sources, including objects derived from scans and objects derived from at least one computer assisted drawing software package, metadata logged in at least one database being associated with at least some of the georeferenced data, these metadata comprising at least one item of information relating to the accuracy with which the position of these georeferenced data in at least one frame of reference is known.

This frame of reference may be an absolute or a relative frame of reference.

What should be understood by “on a planet or sub-planet scale” is that the platform is able to pool and display data the location of which may be anywhere on the planet or over an extensive territory thereof, for example a continent, a country, a region or a town. The platform is thus not restricted to pooling and displaying data confined to a building or to a single located work site. The pooled data may cover sites over 100 km distant for example.

What should be understood by “object derived from a scan” is an object constructed or modeled from actual captured data, for example from capturing the geometry of a building, land, land or underground infrastructure, equipment. The geometry capture may be duplicated by a capture of the texture. In order to perform the scan it is possible to use any suitable optical or electromagnetic acquisition technique, for example a laser scan, notably of lidar type, photogrametry, radargrametry, etc. capture.

What is to be understood by “object derived from at least one computer aided design software package” is a file generated by a computer aided design software package allowing a representation, notably a 3D representation, of the object. This may be any file generated with trade software as used by architects or civil engineers or topographers, for example of the AutoCad or AutoDesk type.

The invention offers numerous advantages.

First of all it allows the information relating to the occupancy of the ground and of the subsoil to be centralized, thereby facilitating access to the relevant data in order to plan an intervention, for example, and allows uplink and downlink exchanges of information between a broad and diverse spectrum of platform users. The platform may be designed to allow for example works or site data to be displayed on a map, all of this with an accuracy compatible with the work that is to be carried out, for example making it possible to view the layout of foundations, networks as built, trenches, the results of geological surveys, this list being nonexhaustive.

The duration of the site work is thereby shortened, and the risks of holing a pipe or of hitting a buried electric cable are thereby reduced.

In addition, the platform is constantly augmented by the data input by the users working on a site, and it is thus possible to become better and better acquainted with the position and nature of the buried networks as interventions gradually progress.

The platform may also include tools which automatically extract the relevant information with regard to the location of buried networks from data downloaded by the various participants working on the site, as explained later on, something which allows the platform to be augmented by metadata, making it increasingly comprehensive over the course of time.

What is meant by “user” is a client (in the computing sense) of the platform, who connects to the platform via a terminal which may be of any type. The aforementioned geolocated data may include data associated with the design, the construction and/or the exploitation of a building or of an infrastructure on the surface or underground. The geolocated data may cover all of a national or regional territory, and include data corresponding to respective work sites, works or equipment distant by more than 100 km, as mentioned above. The digital platform makes it possible to encompass more than an urban digital model, and offers increased possibilities for combating the lack of reliability hitherto encountered on many sites.

According to one preferred implementation of the invention, the platform is designed to allow a plurality of users to connect remotely thereto via terminals and to allow access to certain data to be reserved for a predefined user group, this mode of operation being referred to as “closed mode” or, on the other hand, make these data available to all users, this mode of operation being qualified as “open mode”.

The data may be data relating to the subsoil and/or to objects incorporated into the ground. These data may correspond to data captured during on-the-ground measurement campaigns or sinking bore holes, or to data that is “interpreted”, which means to say estimated from theoretical models.

These data may be derived from geotechnical testing, piezometric measurements, hydrochemical analyses performed in situ and/or at the laboratory. For example, these data may relate to the hydrological and/or hydraulic mechanical properties of the ground, such as the compression and/or shear strength, the water content, the degree of saturation or the permeability, data relating to the geothermal characteristics of the ground or else to the particle size distribution thereof.

Furthermore, the data may include data that provides information regarding reserves of useful substances: ores, coal, water, hydrocarbons, quarry materials or aggregates, to name but a few.

The data may also include data relating to underground installations, for example a gallery, a tunnel, a network of gas pipes, an electricity network, a network of optical fibers, a telecommunications network, a network of urban heating pipes, of drinking water pipes, or a sewage network.

The data logged in the database may comprise photographs, for example panoramic images, orthophotographs, notably aerial and satellite images or else images of the elevation type.

The data logged in the database may also comprise data derived from laser scans, notably in the form of point clouds.

A model of the objects in the platform may thus be obtained by using techniques such as, for example, lasergrametry, photogrametry, interferometry or else computer aided drawing (CAD) techniques.

The platform is advantageously designed to allow a user to select an object, notably a place, a work and/or an item of equipment in order to access and/or download geolocated data relating thereto, these data being delivered by the platform together with information relating to the accuracy with which the position of these geolocated data is known, notably in a frame of reference.

Thus, a new user of the platform has available to him information regarding the accuracy of the geolocation information provided by a previous user of the platform and can adapt the work accordingly. For example, the number and position of the preliminary bore holes may be adapted according to the accuracy of the information. The more accurate the information, the more the number of preliminary bore holes or radar soundings can be reduced.

If desired, it is possible to certify the accuracy of certain data regarding their geolocation, by, for example, performing a later on-site verification or by imposing compliance with a particular procedure when a user is supplying geolocation information. This information may be certified by a blockchain for example.

It is possible to generate a confidence index regarding the location accuracy declared for certain data. If there is a high confidence index, it may be possible to avoid or limit the sinking of preliminary bore holes or the conducting of preliminary surveys.

The platform may comprise geological data of the subsoil having a geolocation accuracy, in a frame of reference, of better than 1 m and/or being designed to allow such data to be logged on the platform.

Thus, when core samples are taken or bore holes are sunk, because the accuracy of the location of the tool in a frame of reference is known, the data resulting from these core samples or bore holes can easily be indexed in the platform and used later by other users to determine the precise nature of the subsoil at a location.

In order to facilitate the input of information, the platform is advantageously designed to allow a user to attach documents to an object, notably a place, work, piece of equipment or other object indexed by the platform, for example present on a map displayed on the user's terminal. For example, documents, for example photographs, may be attached to each object displayed on the map and viewed directly or through a third-party application. It is possible to attach to an object parameters pertaining to subscription, on-going and forthcoming actions on this object and time-related information, for example a date of creation, of update, or the like, and a change history. Attaching photographs may offer advantages in terms of simplicity as far as the user is concerned, as the user can thus easily augment the database, and in terms of subsequent processing options, using automatic image analysis for example in order to recognize and count the equipment or take measurements or determine their condition or precise location, when a geolocated point of reference on the photograph so permits.

The platform may be designed to offer all or some of the following functionalities:
of allowing a user to upload an application to make it available to other users of the platform and allow them to run it within the platform in order to process their data; for example, a user may upload to the platform an application that other users can run when they connect to the platform in order to process their data, for example to produce statistics, predict how a work will age from a certain number of parameters taken from the terrain and/or historical;
of allowing a user to share information with other users of the platform and/or of allowing at least two users to collaborate through the platform by exchange of data between these users or via multiple access to information; that may facilitate the transmission of information between various participants on the one same work site, belonging to various trades, and reduce the risks of errors or facilitate the planning of interventions; for example one user may upload photographs which may be able to be viewed by other users, notably users belonging to a group of users authorized to access these data;
of allowing a user to log his data directly and/or to download it from a third-party database; for example, a user may log on the platform a scan of a work as constructed, or log his data present on a site hosting a digital model, onto the platform;
of allowing a user to create a customized user profile and to interact with the platform via a customized interface; for example, a GIS specialist may create a different “trade” profile from that of an architect or a site manager; the option to create a specific profile may allow users to access the relevant information more quickly;
of allowing a user to log in the platform data relating to various objects, notably works and/or items of equipment as constructed, at least some of these data being data that is geolocated in a frame of reference;
of allowing a user to augment the works and/or equipment data listed in the platform with metadata chosen notably from among the name of the work or of the equipment, a characteristic of the work, a date, notably a construction date, and so as to allow a user to carry out multicriteria searches on these elements;
of allowing a user having carried out an intervention at a place or on a work and/or item of equipment listed in the platform, to log in this platform a score representative of the reliability of the logged data, notably the reliability of the geolocated data location accuracy information, a confidence index preferably being calculated from the scores logged by the previous users and supplied to each new user seeking to download these data;
of allowing a user connecting to the platform to interrogate this platform as regards the evolution of at least one parameter pertaining to a work and/or to an item of equipment, and to obtain in return, through a prediction tool, a prediction regarding the future of said parameter, the prediction tool having been generated by processing data logged on the platform using an artificial intelligence engine or using a statistical analysis technique; for example the mass of data present on the platform relating to a parameter representative for example of a breach of the water table is analyzed in order to look for the best clues indicative of such a breach, which then allows a more rapid reaction when confronted with such a risk by taking the required actions; data relating to the aging of works according to the materials used, the construction techniques employed, the environmental conditions and the exploitation of the work, for example the logged traffic, can be analyzed in order to generate a model that predicts how the work will age according to certain parameters, so that maintenance can thus be adapted accordingly;
of supplying information to make it possible to steer a plant or assist an operator using augmented reality.

The geolocated data logged in the platform may comprise data connected with the design, construction and/or operation of a building or of an infrastructure on the surface or underground, such as an existing one.

The platform may be designed to run an application for analyzing the correlation between at least two 3D models relating to the one same work or item of equipment and according to the correlations detected generating a new 3D model by using data fusion to merge the two models analyzed. This may improve the use of the platform by reducing the number of files giving the benefit of easier access to the desired information.

The platform may receive, notably in real time, data from sensors or meteorological, thermal, satellite, notably pertaining to the relief of the ground, traffic and/or seismic activity data and allow at least one user to access and/or download these data. These data may beneficially be fed into predictive analysis engines with a view to assisting with predicting certain phenomena. The data may originate from sensors installed on the infrastructures or in the ground and of very diverse type, for example making it possible to monitor pressure, separation, vibrations, piezometry, inclination, these sensors being used for example in the phase of constructing a tunnel in order to monitor to ensure that nothing is happening at the surface. These may also be sensors which provide environmental data for an infrastructure management phase, for example measuring a level of usage. Alternatively, the issue may be that of detecting the aging of an infrastructure and of optimizing its repair and its total cost of ownership, for example so as to know when to intervene and to plan repairs, of roadways for example or other infrastructures. The receipt of data in real time makes it possible to make communications more fluid, limit losses of information, reduce the use of obsolete information, the duration of the projects and gain better control over the risks of accidents. That may also make it possible to produce reliable statistics on work sites so as to reduce the risks of accident.

The platform may advantageously run an application to automatically convert a format in which a file has been downloaded into a predefined format and display, on the one same map, information originating from different files, at least one of which has undergone this conversion. Thus, the user is relieved of the burden of performing conversion operations and the data can be more easily used by the platform. The format of the data logged in the platform is, for example, an open or proprietary format, for example chosen from DWG, Ascii, OBJ, vector image, CVS, LAS or open source format such as IFC.

The platform may comprise:
a data storage layer allowing the storage of data, notably geolocated data, transmitted by users to the platform,
a data management layer allowing control of access to the platform, the indexing of data, the exporting or importing of data,
a macrofunctions layer of macrofunctions supplied to the users,
an interface layer for interfacing with the users.

The data storage layer may comprise:
a data lake,
a relational database preferably comprising all the structured information of the platform, and notably the metadata allowing access to the information stored in the data layer, notably fact indexing data such as the spatio-temporal coordinates, fact groups, hierarchies, key words, and allowing management of rights of access to the facts,
a database, preferably of noSQL type, for storing unstructured data, notably data originating from sensors,
a storage space, preferably of the file server type, to receive files associated with the facts, and
a document management space, preferably of the electronic document management type, providing the users with an information sharing and exchanging space.

The data management layer may be accessible to the macrofunctions layer through an API, making it easier to create a catalog of applications managed in a store, for example of a “Playstore” type. The APIs allow the users to create applications which process their data.

The platform may be configured to offer all or some of the following functionalities:
a multicriteria access service for searching on and providing read-access to the facts,
a service controlling access to the facts, making it possible to guarantee the security of the data,
a service for extracting and exporting facts, to various formats,
an access accounting service to measure the level of usage of the APIs and various types of data,
an import service that also includes block or individual updating, making it possible to augment, translate the format, filter, hierarchize, validate and clean the data during import,
a data transformation service configured to harmonize the indexing of the data, notably in terms of geospatial referencing, to correlate data that meets certain criteria, notably criteria of geographic proximity, in order to clean and/or augment certain external data; that allows the platform to manage changes in reference quickly and fluidly. This is advantageous insofar as there are, worldwide, dozens of official references and thousands of private references; for example, for an open cast mine, all the sensors and the satellite points are in a frame of reference local to the mine; certain objects may be referenced automatically according to a specific purpose, for example to find all the water meters in an area and take readings therefrom.

The macrofunctions layer may be designed to perform all or some of the following functions, and preferably all of the following functions in full:
of creating and managing a user account on the platform,
of browsing the facts logged on the platform using a browser,
of accessing platform data from applications external to the platform, and
of managing the data sources.

The browser may be designed to offer all or some of the following functionalities:
of allowing the viewing of a map, preferably of GIS type, with a 2D, 2.5D or 3D rendition according to the level of zoom, the browser preferably being designed to allow the display of a catalog of available map backgrounds and the selection of one or more map backgrounds, and to display at least some of the information of the selected map backgrounds in overlay and notably make it possible to change the order in which the map backgrounds are overlaid within the map displayed and/or implement action or information markers on a map;
of allowing a selection frame deployed over a map to be displayed and/or being designed to calculate the distance between two points or objects, for example between two valves connected by a pipe or the width of an infrastructure, for example of a road, the projected distance, the area of a selected zone, the projected area, preferably with the possibility to select the color and/or the transparency of the selected zone and how it appears according to the level of zoom;
of allowing the creation of a bar graph and longitudinal sections representing a stratigram of the subsoil;
of allowing an attribute to be assigned to an object featured on the map and this attribute displayed in a predefined format;
of allowing a group of objects to be created and shown as such on the map;
of allowing parameters connected with the objects appearing on the map to be displayed automatically, these parameters notably including the surface area of the objects, the number of objects per type, the number of connected documents;
of allowing a search by coordinates in a frame of reference;
of offering tools for measuring a distance on the map, a surface area, for editing an altimetric profile, for calculating an isochron, for measuring an azimuth and/or for simulating the lighting of a site according to the time of day;
of allowing a search profile to be defined and memorized, notably making it possible for the predefined search fields associated with a user identifier to be displayed automatically.

The user interface layer may comprise at least one of the following:
an interface of web type,
an interface of mobile app type,
an interface of API gateway type,
a blockchain interface, notably an interface comprising a blockchain node, preferably of hyperledger type (blockchain development open source platform).

Another subject of the invention is a method for logging data relating to a site or work, comprising the step consisting in performing at least one geolocated optical acquisition, preferably a geolocated scan, of the site or of the work, and in uploading this acquisition, together with information georeferencing the acquisition in a frame of reference, into the computer platform according to the invention.

The method may comprise the step consisting in also uploading into the computer platform information relating to the accuracy with which the georeferencing information is known, the acquisition notably being performed by remote detection using a laser or by means of at least one camera. As an alternative, the capture may be performed by radar, for example a radargram.

The method may comprise a processing of the acquisition by an object recognition tool available on the computer platform with data relating to the site or to the work being augmented with metadata derived from this processing. For example, when the capture relates to a buried network, the recognition tool may automatically recognize the pipes, valves or other elements of the network and index them. This may make it possible to compare the reality observed on the ground with the digital model from which the network was produced, and update the digital model to facilitate subsequent interventions and benefit from this feedback. The recognition tool may, if appropriate, generate a representation of the network in the form of arcs and nodes.

Yet another subject of the invention is a method for determining at least one model predicting the occurrence of an event, comprising a statistical and/or artificial-intelligence treatment of data logged on the platform according to the invention in order to find a connection between certain input factors and the event and to generate said predictive model.

Yet another subject of the invention is a site monitoring method comprising the step consisting in equipping a zone with at least one site monitoring geolocated instrument and in downloading, notably in real time, into the computer platform the invention, data derived from this instrument.

What is meant in the invention by “real time” is an updating of the data in the platform that is performed at a higher frequency than one update every hour, better, every 30 minutes, better still, every 15 minutes.

Yet another subject of the invention is a method for performing an intervention, notably in the subsoil, comprising the steps consisting in:
connecting to the platform according to the invention, and downloading geolocated data relating to a place and/or work involved in the intervention,
performing the intervention on the basis of these data, and preferably publishing an intervention dossier regarding the site work online on the platform.

The intervention may include digging an excavation and/or sinking a bore hole.

The intervention may be carried out according to the accuracy with which the position of the geolocated data in a frame of reference is known, as supplied by the platform, notably making it possible to limit the risk of hitting and damaging an existing underground network and thus limit the risk of physical accident.

Yet another subject of the invention is a method for constructing a works, notably a building or an infrastructure on the surface or underground, comprising the steps consisting in:
downloading and/or viewing geolocated data relating to the surroundings of the work, notably the subsoil thereof, notably in a predefined format, from the platform according to the invention,
carrying out the work with consideration to the downloaded data and their updates, notably in real time, making it possible to limit rework, and preferably performing the work in a coordinated manner with the information relating to infrastructure elements of a geographic nature, such as information regarding networks or buildings being shared between the various participants and/or with comments, attached documents and/or reviews pertaining to these elements being shared in real time.

Design data pertaining to the work, data relating to site progress, data relating to the condition of the ground or of the subsoil, data relating to the work as constructed and/or data relating to the maintenance or operation thereof can be logged in the platform.

A further subject of the invention, according to another aspect thereof, is a method for constructing a works, notably a building or an infrastructure on the surface or underground, comprising the steps consisting in:
downloading, from the platform according to the invention, geolocated data relating to the environment of the work, notably the subsoil thereof,
creating the work taking the downloaded data into account.

Design data pertaining to the work, data pertaining to the site progress, data relating to the condition of the ground or of the subsoil, data relating to the work as constructed and/or data relating to the maintenance thereof may advantageously be logged in the platform.

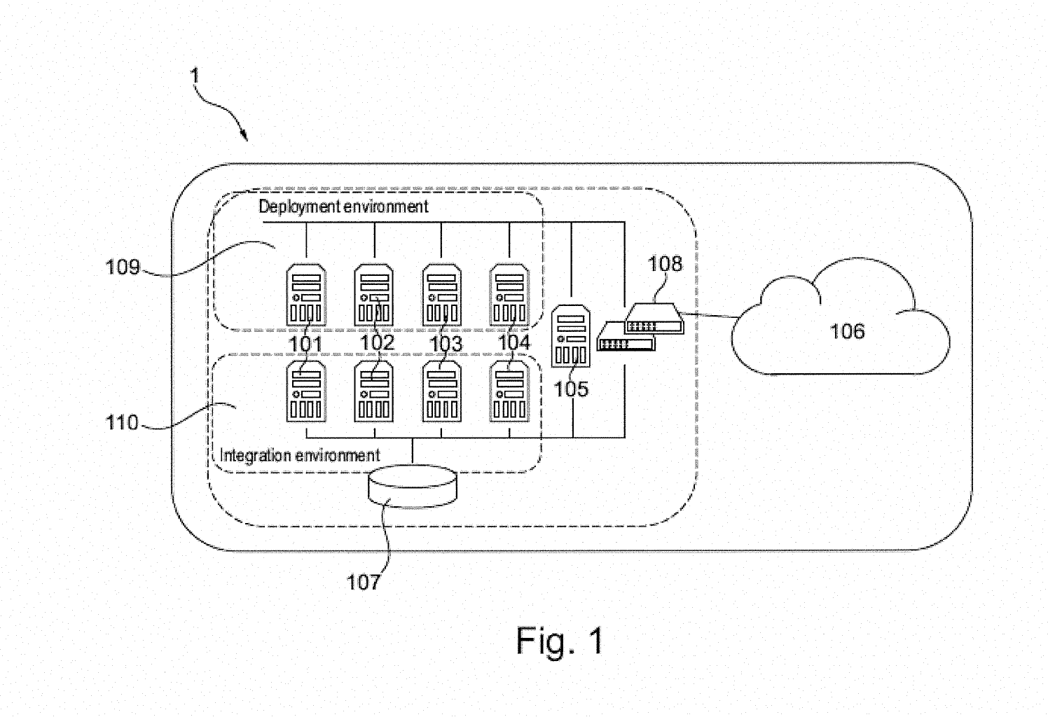

The invention may be better understood from reading the detailed description which will follow, of nonlimiting exemplary embodiments of the invention and from studying the attached drawing in which:
FIG. 1 schematically depicts an example of the hardware architecture of the platform according to the invention,

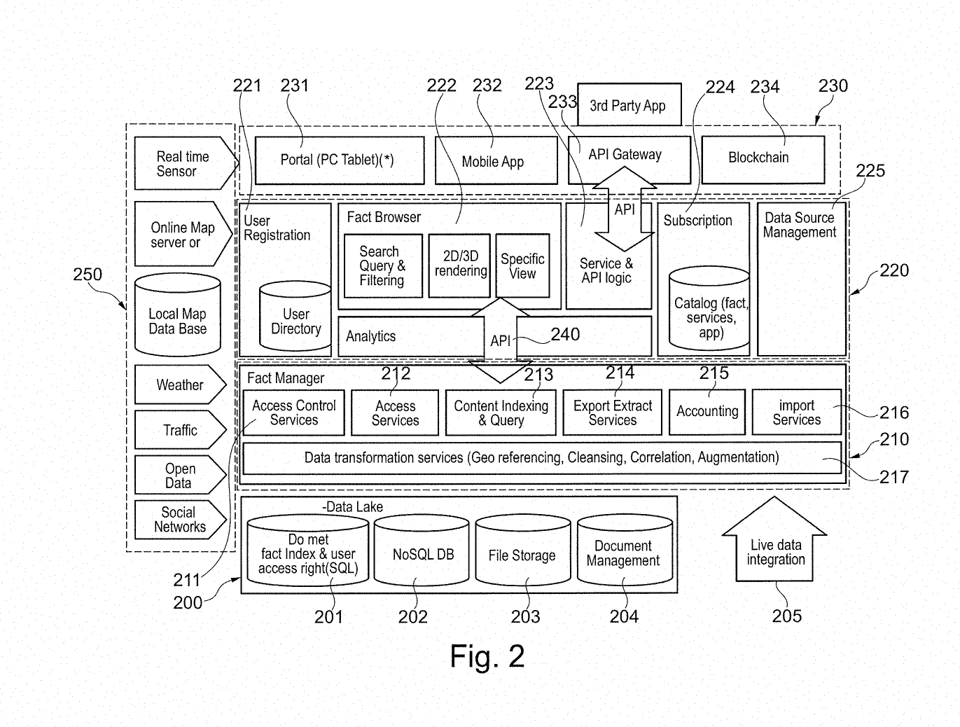

FIG. 2 schematically illustrates an example of the software architecture of the platform according to the invention,

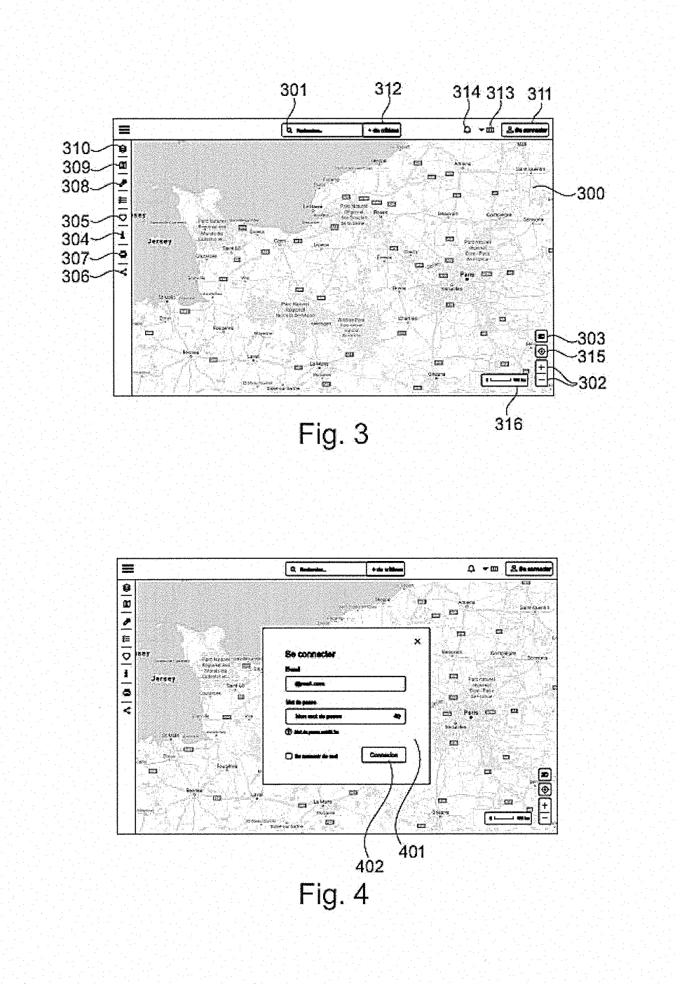

FIG. 3 depicts an example of a map that may appear on the platform browser,

FIG. 4 illustrates the connecting of a user to the platform,

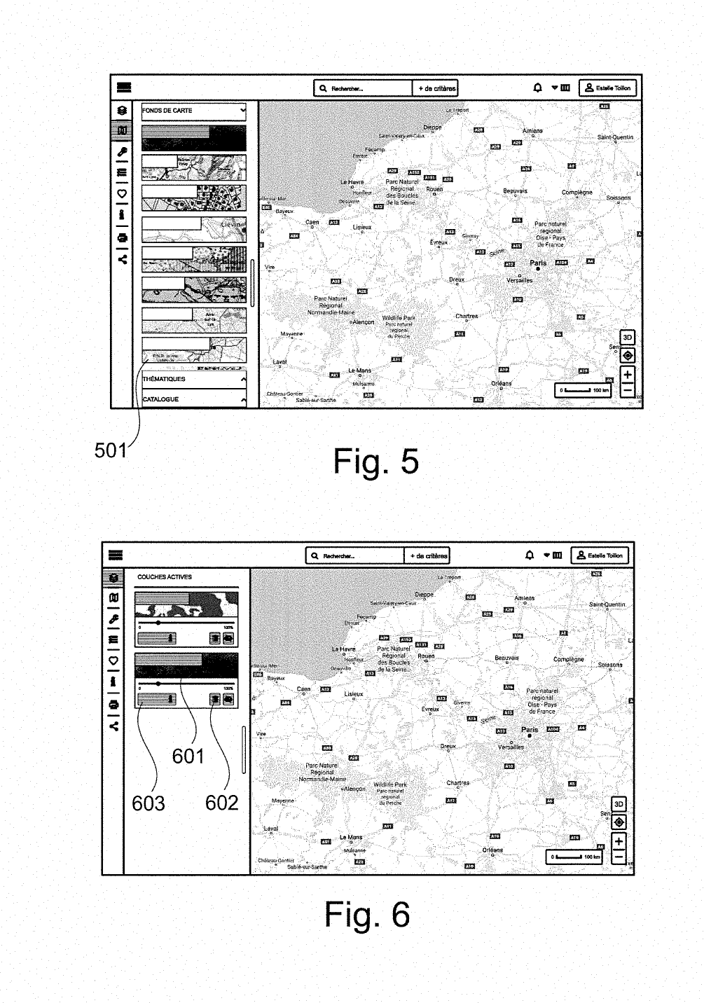

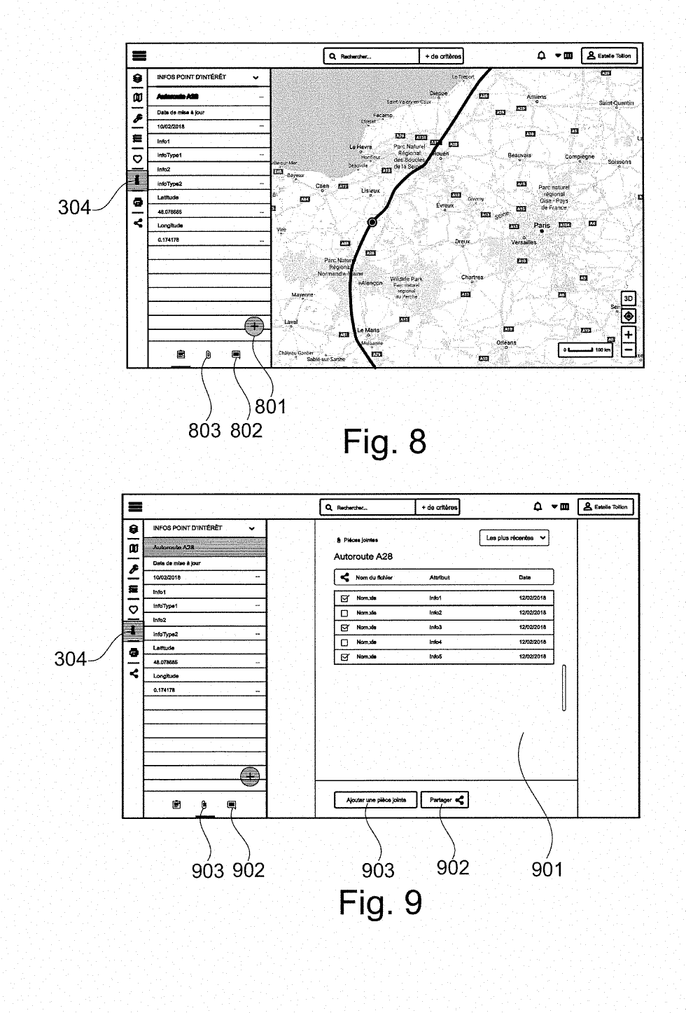

FIGS. 5 and 6 illustrate examples of changes to the display according to the actions performed,

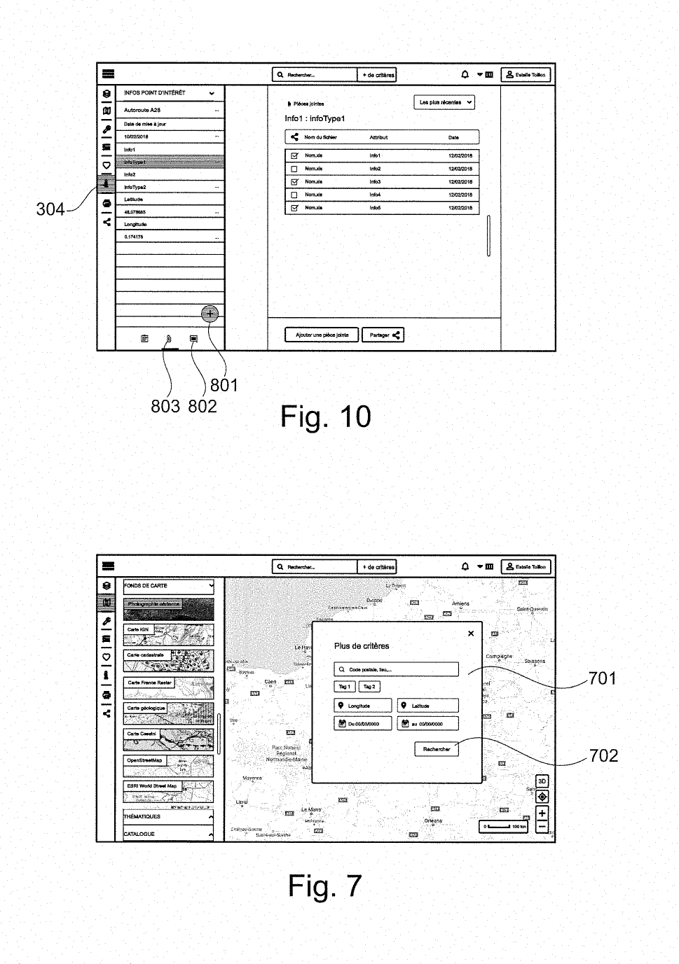

FIG. 7 illustrates the possibility of conducting a geolocated search,

FIG. 8 illustrates the display of a map with information regarding a point of interest,

FIGS. 9 and 10 illustrate the possibility of adding geolocated information,

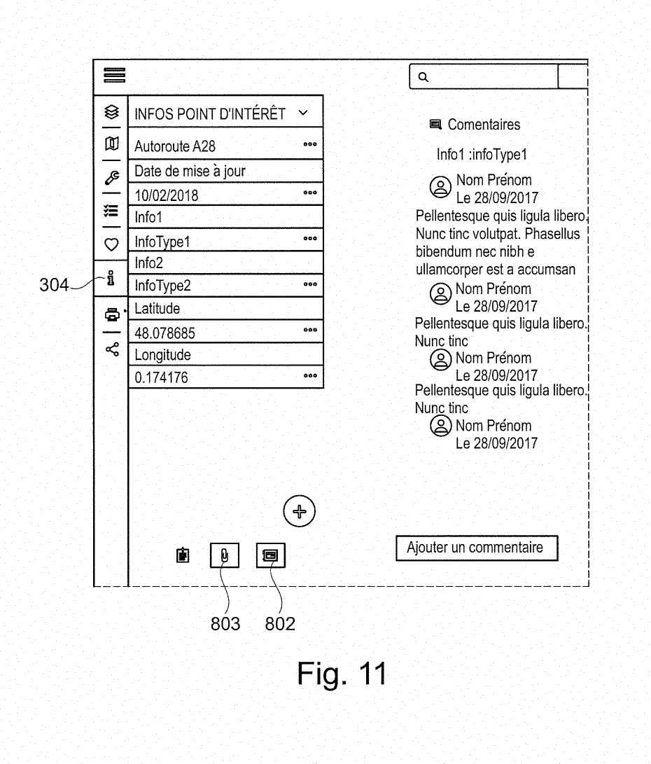

FIG. 11 illustrates one example of a user comment,

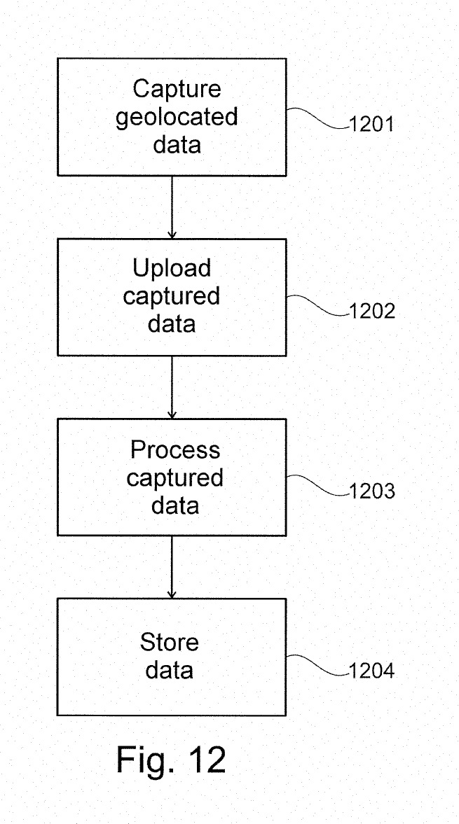

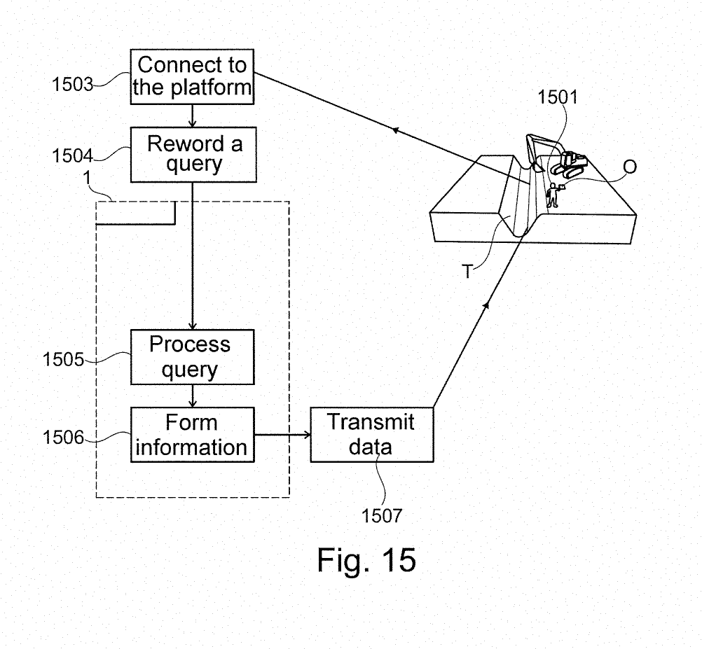

FIGS. 12, 13, 14 and 15 are block diagrams illustrating various steps in example methods involving a platform according to the invention,

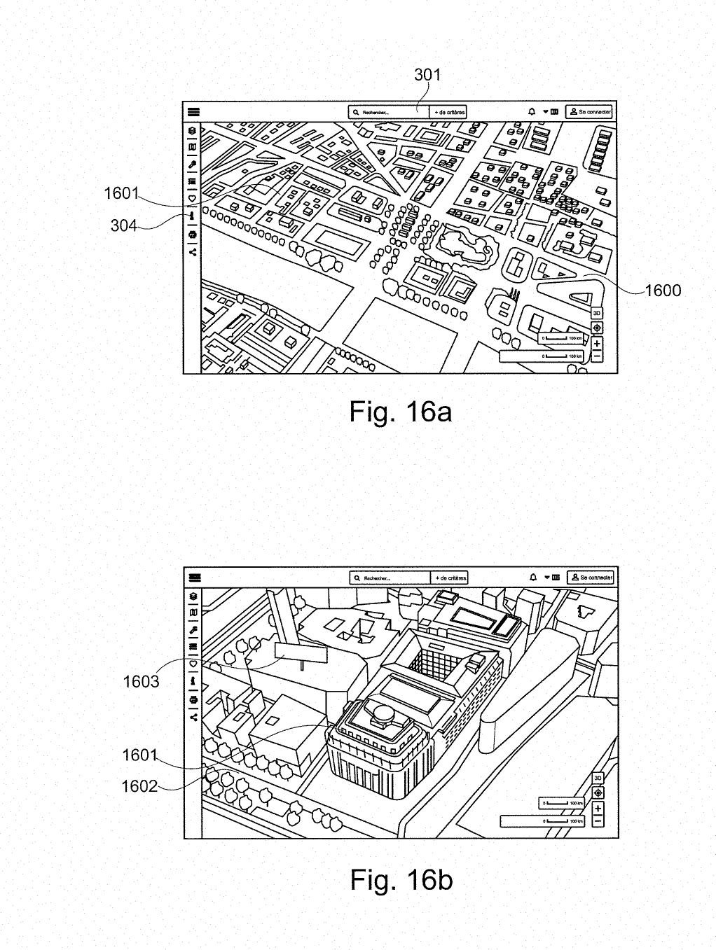

FIGS. 16a and 16b show an example of a map illustrating an urban environment,

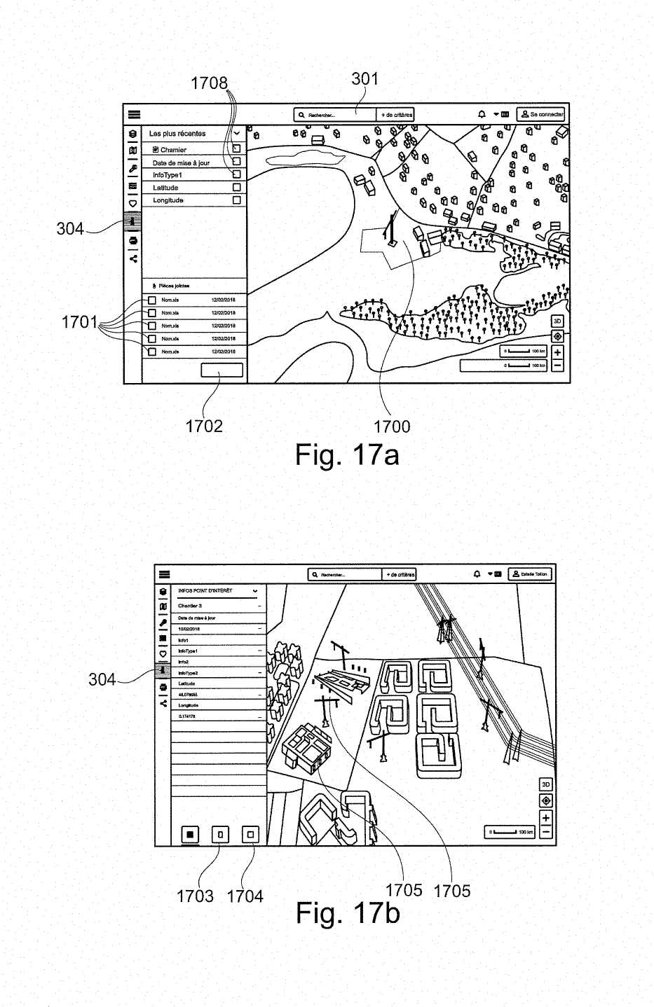

FIGS. 17a and 17b depict an example of a map illustrating a work site,

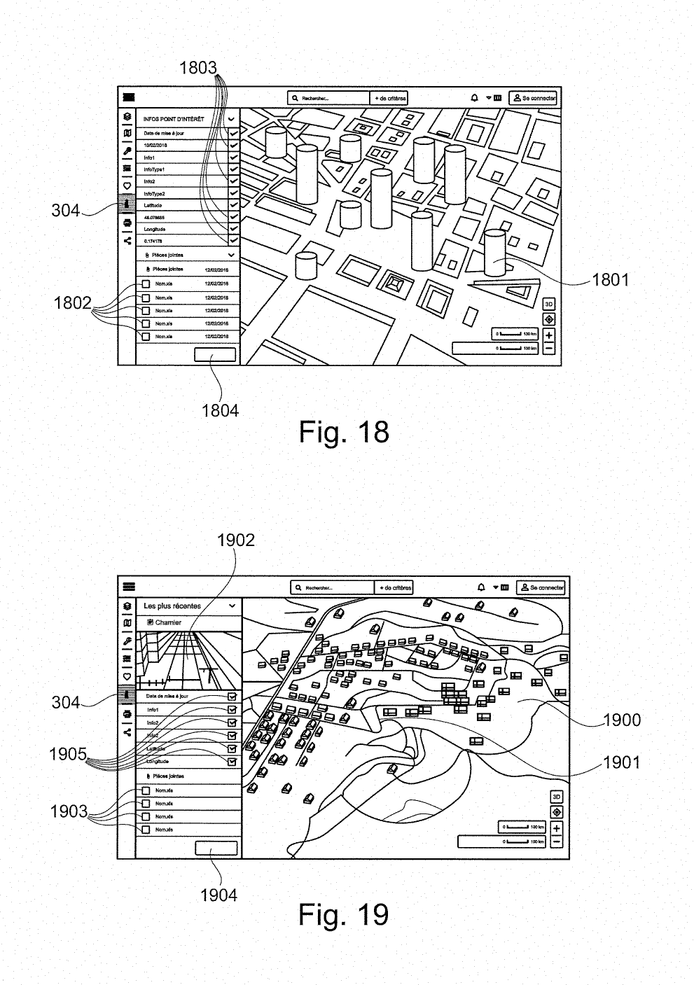

FIG. 18 depicts a map with information regarding surveys,

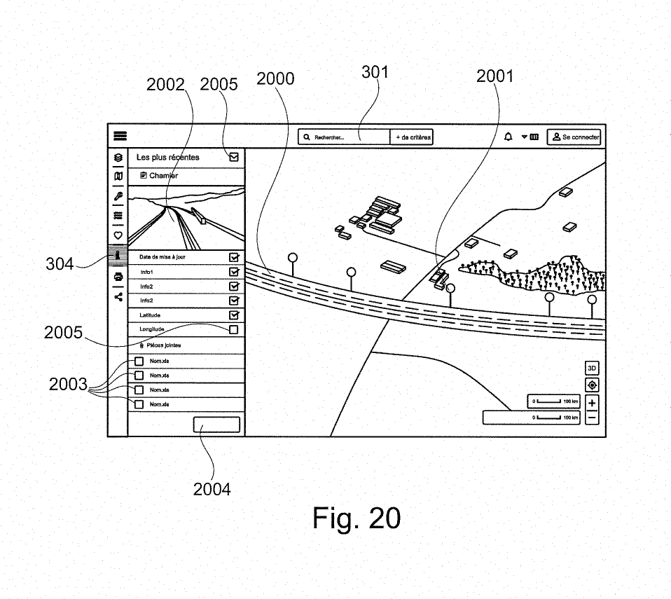

FIG. 19 is an example of a map that may appear on the platform browser, showing an example of a buried network, and

FIG. 20 depicts an example of a map illustrating a motorway.

FIG. 1 schematically depicts an example of the physical architecture of a computer platform 1 according to the invention. This platform comprises a collection of virtual servers, preferably in a cloud, for example as illustrated: a Web server 105, one or more application servers 104, one or more SIG servers 103, one or more analytical servers 102, one or more data servers 101, one or more storage servers comprising a backup device (not depicted). These servers may have multi-core microprocessors, for example dual-core or quad-core microprocessors. These microprocessors may be AMD, IBM, ARM or Intel microprocessors. The servers may have an operating system of the REHL type, notably an REHL 6.0 operating system. These virtual servers may potentially comprise particular agents. Each virtual server is identified, within the architecture, by at least one server identifier. Each virtual server may be associated with one or more virtual memory disks, for example with a capacity of 4 GB, 8 GB or 16 GB. The user may access the platform 1 through a network 106, for example of the Internet type, accessing one or more virtual servers of the collection of servers which is or are dedicated to him. This access is had for example by means of the identifier of the dedicated virtual server, and a key specific thereto. The architecture may also comprise firewalls 108. The architecture further comprises, as illustrated, a storage unit 107.

The architecture of the platform 1 can be split into two environments:
public environment 109 dedicated to deployment, control and development,
a private environment 110 dedicated to integration and deployment.

The data server 102 is able to supply and/or receive diverse data, notably data relating to objects derived from scans and data originating from computer aided design or computer aided drawing software. These data may relate to infrastructures, buildings, polylines polygonal-text lines, active or passive markers, bar graphs, real time data, map background, catalog, network with node and arc and objects library, to name but a few.

The format of the data logged in the platform may be an open or proprietary format of a certain number of varieties (DWG, Ascii, OBJ, vector image, CVS, LAS to name but a few).

The SIG server 103 allows SIG data to be stored and restored to the users. These data may be logged directly on each SIG server or accessible from third-party SIG platforms.

The network 106 may be any type of communications network, such as a local network, for example an intranet, an extended network, for example Internet, or a combination of these. As an alternative, the network 7 may be a direct connection between a user and the platform. In general, communication between the platform and a user can be achieved via any type of wired and/or wireless connection, using a wide variety of communications protocols, for example TCP/IP, HTTP, SMTP, FTP, codings or formats for example HTML, XML, and/or protection systems VPN, HTTP Secure, SSL.

The Web server 105 is able to host Web applications.

The software architecture of the platform is illustrated in FIG. 2. It comprises four main layers:

a data storage layer 200 for storing data, notably geolocated data transmitted by users to the platform,

a data management layer 210 allowing control of access to the platform, indexing of data, importing and exporting of data,

a layer 220 of macrofunctions provided to the users,

an interface layer 230 for interfacing with the users.

The platform may be designed to interface with external data suppliers 250, notably selected from among
a map information system or map server
a meteorological data server
an open data server
one or more social network servers
one or more sensors which in real time receive meteorological, thermal, traffic and/or seismic activity, fissure, earth movement data.

The data storage layer 200 of the platform according to the invention may comprise:

a data lake 201. This is configured to contain the structured data originating from relational databases in rows or in columns, semistructured data such as CSV, logs, XML, JSON, and unstructured data such as emails, documents and PDFs. It may also contain binary data such as images, audio files or videos. The data lake 201 may advantageously comprise:

a relational database 202. This database preferably comprises all the structured information of the platform, and notably the metadata allowing access to the information stored in the data layer, notably fact indexing data such as the spatio-temporal coordinates, fact groups, hierarchies, key words, and allowing management of rights of access to the facts,

a database 203, preferably of noSQL type, for storing unstructured data, notably data originating from sensors. An example of a noSQL database service may be the IBM Cloudant service. This service stores data in the form of J SON documents,

a storage space 204, preferably of the file server type, to receive files associated with the facts,

a document management space 205, preferably of the electronic document management type, providing the users with an information sharing and exchanging space.

The data storage layer may also be configured to allow direct real time integration from information sources external to the platform.

The data management layer 210 interfaces the storage layer 200. It makes it possible to take into consideration the heterogeneity of the various information sources and typologies in order to give a harmonized view of these through the concept of facts. It is configured to offer the following functionalities:

a service 211 controlling access to the facts, making it possible to guarantee the security of the data,

a multicriteria access 212 service for searching on and providing read-access to the facts,

a service 213 of indexing and querying the data contained in the data lake 2001,

a service 214 for extracting and exporting facts, to various formats,

an access accounting service 215 to measure the level of usage of the APIs and various types of data,

an import service 216 that also includes block or individual updating; this service makes it possible to augment, translate the format, filter, hierarchize, validate and clean the data during import,

a data transformation service 217; this service is configured to harmonize the indexing of the data, notably in terms of geospatial referencing, to correlate data that meets certain criteria, notably criteria of geographic proximity, in order to clean and/or augment certain external data.

The data management layer 210 is preferably accessible to the macrofunctions layer 220 via an API 240. The macrofunctions layer may comprise several components including:

a user directory 221 which makes it possible to create and manage a user account on the platform. The creation of a user account is performed in conjunction with basic identification elements, for example the email address or the professional registration number. The user directory 211 also allows management of an identifier or of a password that has been forgotten and changes to elements of the profile including the password, preferably using an online SMTP server functionality.

a facts browser 222 which allows the users to browse the facts logged on the platform, access platform data from applications external to the platform, and manage data sources. The browser allows the viewing of a map, preferably of GIS type, with a 2D, 2.5D or 3D rendition according to the level of zoom; the browser is preferably designed to allow the display of a catalog of available map backgrounds and the selection of one or more map backgrounds, and to display at least some of the information of the selected map backgrounds in overlay and notably make it possible to change the order in which the map backgrounds are overlaid within the map displayed and/or implement action or information markers on a map;

an API logic 223; this logic makes it possible to implement platform application programming interfaces and services; this component makes it possible to run the logic providing access to basic or augmented data, from external applications; the facts browser 222 and the API logic 223 may call upon a cognitive or analytical service cross-cutting component making it possible to provide augmented data, for example trends, predictions or recommendations.

a subscription component 224; this is a service for subscribing to the products offered by the platform; this component may employ several product catalogs notably service registries, data catalogs, “App store”, etc;

a data source management component 225; this allows new data sources to be taken into consideration simply and quickly and allows new fact typologies to be created.

The macrofunctions layer is able to communicate with the interface layer 230 by means of an API 240. The interface 230 of the platform may comprise at least one of the following:
a Web type interface 231 accessible either from a PC or from a tablet providing access to all the functions of the platform;
an interface of the mobile app type 232, which can be used from a smartphone or a tablet;
an interface of the API gateway type 233 providing secure and public access to the facts and services from third-party applications;
a blockchain interface 234 to secure the sharing and exchange of information with clients or partners; the blockchain interface may comprise a blockchain node, preferably of hyperledger type, with which clients and partners can work directly, or may interface with other blockchain nodes operated by major partners.

The user may, by means of the interface, create and have his customized environment of readily accessible data.

FIG. 3 depicts one example of a map that may appear on the platform browser.

The user interface may comprise an interactive zone for displaying maps 300, a share icon 306 to allow the user to share the map on social media, an icon 307 for printing the map, a search box 301 to allow the user to perform a search using key words, for example an address, a structure (underground network, pipes, electricity), an item of equipment (valve, pipe, etc.); this search can be customized by adding criteria such as, for example, the type of material, the dimensions, the construction date, etc. This customized search is performed for example by clicking on the icon 312. The user can also click on a characteristics information button 304, on map scale information 316, on zoom selectors 302, on an icon 315 for activating/deactivating the geolocation, on an icon 313 for choosing a language from a list of available languages, on an icon 311 to connect to the user account, on an icon 314 to create an alert, for example to alert the user to a change, which is useful when monitoring site work or flagging when information is available, on an icon 310 to allow the user to choose a map background from a catalog of available map backgrounds, on an icon 309 to choose an active layer, on an icon 308 to allow the user to adjust the parameters of the interface, or on an icon 305 to log points of interest as favorites so that the information associated with these selections can be consulted more easily and directly later.

The user may interact with the interface of FIG. 3 by for example touching the display when the display is a touch-sensitive display and/or by using a mouse pointer to click on the various elements of the interface.

The user can interact with the interface by scrolling or moving up, down and/or side to side; or by zooming in or out. The user may interact with the map 300, for example by rolling over and/or by clicking on various characteristics.

FIG. 4 illustrates the connecting of a user to the platform. This figure is analogous to FIG. 3 over which an additional window 401 has appeared, allowing a user to be identified by inputting an identifier such as an email address or a telephone number, for example, together with a password.

FIG. 5 illustrates an example of how the display changes according to the map background. The user may choose a map background from a list of map backgrounds which is available in a catalog 501, by clicking on the icon 304. This catalog contains for example aerial photographs, IGN maps, cadastral maps, France Raster maps, geological maps, Cassini maps, OpenStreetMap maps or maps of the ESRI World Street Map type.

FIG. 6 illustrates an example of how the display alters according to the choice of active layer. The user can access a catalog of active layers by clicking on the icon 304. He can choose a layer from the list available by clicking thereon. The display of the map 300 then changes accordingly.

FIG. 7 illustrates the possibility of performing a geolocated search. The platform allows the user to perform a customized, notably geolocated, search by clicking on the icon 304. FIG. 7 shows an example of a window 701 dedicated to the customized search, where the user can input information regarding the object of his search, notably its geodesic longitude and latitude coordinates. The search may be begun by clicking on the icon 702.

FIG. 8 illustrates the display of a map with information regarding a point of interest. The user may obtain information about a point of interest by clicking on the icon 304. The information may relate to its location, notably its geodesic coordinates, the accuracy of the coordinates, the date of update. The user may also add data by clicking on the icon 801. The icon 802 allows the user to log comments regarding the point of interest. One example of a comment is illustrated in FIG. 11. The user may also add metadata regarding the object of interest in the form of an image or of a video for example.

The platform allows the user to log geolocated information regarding a point of interest and information relating to the accuracy with which the position is known within a frame of reference of this information. FIGS. 9 and 10 illustrate the possibility of adding geolocated information. The addition of this information may be performed by clicking on the icon 902. The format of the data may be selected from DWG, Ascii, OBJ, vector image, CVS, LAS, to name but a few possibilities.

The platform 1 according to the invention may be augmented with geolocated data in numerous ways, for example as illustrated in FIG. 12, by performing, at step 1201, at least one geolocated optical capture, preferably a geolocated scan, of a work site or of a work, then by uploading to the computer platform in step 1202 the result of this scan together with information georeferencing the capture in a frame of reference. It is beneficial also to upload into the computer platform information regarding the accuracy with which the georeferencing information is known. The capture may be performed by remote detection using a laser, using at least one camera or using a radar. The capture may be processed by an object recognition tool available on the computer platform, in step 1203. In step 1204, the corresponding data may be logged in the platform to augment the platform with data relating to the work site or to the work in the form of metadata derived from this processing.

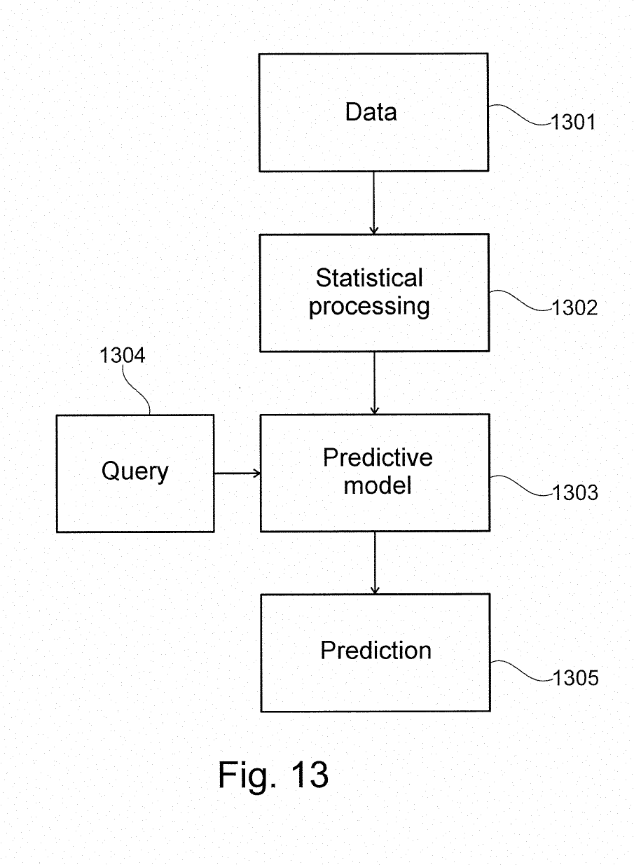

The platform may also be used to determine at least one predictive model predicting the occurrence of an event, as illustrated in FIG. 13. In that case, the data to be processed is selected in step 1301, then the selected data are processed 1302 statistically and/or using artificial intelligence, for example using Watson, so as to discover a connection between certain input factors and the event and at step 1303 generate a predictive model.

A query can then be formulated in step 1304, with data relating for example to a given site or work, the previously-determined predictive model can be applied and in step 1305 a prediction can be obtained relating to the data input at step 1304.

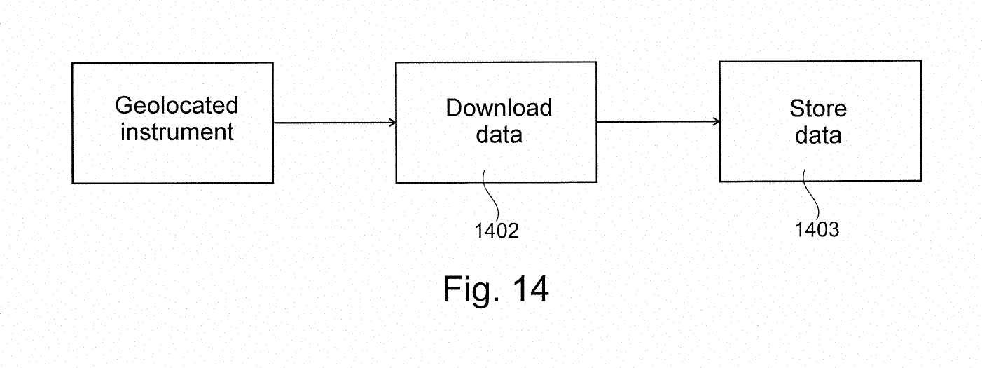

The platform may make it possible to monitor site work, by, as illustrated in FIG. 14, equipping a zone with at least one site monitoring geolocated instrument and by uploading in step 1402, notably in real time, data derived from this instrument to the computer platform. The resulting data may be stored in the platform in step 1403.

The platform may be used to carry out an intervention in the subsoil, for example to dig a trench T as illustrated. In that case, the operator O who is to carry out the work connects to the platform 1 in step 1503, using a terminal 1501 such as a tablet for example. Once the connection is established, he sends in step 1504 a query regarding the nature of the equipment buried in the zone to which the work relates. The platform processes the query in step 1505 and in step 1506 generates data, for example in the form of a 3D model of the zone that allows the buried networks and their position in a frame of reference or their relative position, namely their position in the frame of reference of the work site to appear on the terminal 1501. Next, these data are transmitted to the operator in step 1507. The operator can perform the intervention on the basis of these data. If need be, these data may appear in augmented reality, on a helmet worn by the person tasked with digging the excavation or on the windshield or the instrument panel of the item of plant used. The operator may also publish an intervention dossier about the site work online on the platform.

In this example, the operator when performing his intervention takes account of the accuracy with which the position, in a frame of reference, of the geolocated data is known, as provided by the platform. In this way he limits the risk of hitting and damaging an existing buried network and reduces the risk of physical accident.

After or during the course of the intervention, the operator can at any moment upload into the platform a photograph, a video or a laser scan of the ongoing work site, so as to update a digital model of the work site and allow other users to benefit from this.

The platform may also be used in the context of the construction of a works, notably a building or an infrastructure on the surface or underground. In that case, the professionals tasked with this site work may download and/or view, notably in a predefined format, from the platform, geolocated data relating to the environment of the work, notably its subsoil. Next, on the basis of these data and of their update, notably in real time, they may carry out the work. This makes it possible to limit reworks. The work can be carried out in a coordinated manner by sharing information relating to infrastructure elements of a geographical nature, such as information regarding the networks or buildings between the various participants and/or by sharing comments, attached documents and/or reviews on these elements in real time. The documents shared and logged in the database may notably be files derived from computer aided drawing or computer aided design software packages.

The platform may be used to log data pertaining to the design of the work, notably objects derived from the computer aided drawing or computer aided design software, and data relating to the progress made with the site work and related to the state of the ground or of the subsoil. Next, the platform can be used to log data relating to the work as constructed, and data relating to its maintenance or its exploitation.

FIG. 16 depicts an example of a map illustrating an urban environment 1600. The user can access this map by for example performing a keyword search or by indicating the address of an urban zone of interest in the box 301. The user can interact with the map 1600 by scrolling forward or back or by moving up, down and/or side to side; or by zooming in and out. When a user zooms, more detail appears until the entire shape of a building 1601 can be seen. The user can also interact with the map 1600, for example by rolling over and/or clicking on various characteristics. In this way, the user can obtain a desired view of the structures, notably buildings 1601 and roads 1602. FIG. 16b shows a zoomed-in example of a group of buildings 1601. The platform also allows the characteristics relating to the displayed objects to be displayed, for example the name of the buildings and of the roads.

FIG. 18 shows the display of a map with information regarding the results of surveys 1801 performed on the displayed zone, for example geotechnical, piezometric, pollution surveys. The user may obtain information relating to these surveys by clicking on the icon 304. The information may relate to its location, notably its geodesic coordinates, the accuracy of the coordinates, the date of creation and/or of update, the name of the user who provided this information; characteristics regarding the survey, for example the characteristics of the ground, notably the mechanical, hydrological and/or hydraulic characteristics, the ore and/or hydrocarbons content. The platform may allow the user to access a third-party software package that makes it possible to generate a continuous 2D and/or 3D map of the ground or of the subsoil from the discrete data provided by the surveys, for example a geostatistical software. The user may modify these characteristics by clicking on the icon 1803. The user may also download information by checking the check box 1802 corresponding to the information desired and by clicking on the icon 1804.

FIG. 17a shows an example of a map illustrating a work site 1700. The user can access this map by performing for example a key word search or by indicating the address of the work site in the search box 301. The user may thus have an overview of the work site and its surroundings. He may thus monitor the surroundings of the work site, mark access points or take into account how the vicinity of the work site evolves as the site work progresses. The user may access information relating to the work site by clicking on the icon 304; he may also download this information by clicking on the icon 1702.

FIG. 17b shows an example of the work site with a higher level of zoom. The user can monitor the progress made with the site work and obtain information regarding points of interest 1705 thereof, for example a construction or an item of equipment (crane, valve, pipe). The information may relate to the location of the point of interest, notably its geodesic coordinates and the corresponding location accuracy. It is also possible to attach a document to the platform by clicking on the icon 1703, such as, for example, a photograph for example or a site progress report. The user may also add a comment by clicking on the icon 1704, for example a remark, a question, or answer a question posed by another user. The fact that the information is centralized thus allows the users at any moment to access diverse information provided by different operators. Thus, the users of the platform save time and gain efficiency because they are no longer obliged to use several platforms or to contact an operator in order to obtain a piece of information. They can in effect view all the information relating to the work site on one single platform.

FIG. 19 is an example of a map that may appear on the platform browser, showing a buried network, for example a network of gas pipes, an electricity network, a network of optical fibers, a telecommunications network, a network of urban heating pipes, of drinking water pipes or a sewage network. The user may obtain information about at least one point of interest, for example a valve 1901, by clicking on it and on the icon 304. The information may relate to its location, notably its geodesic coordinates, the accuracy of the coordinates, the date of update, a photograph 1902. The user may modify at least one of these pieces of information by clicking on the icon 1905. The user may download the information by checking the check box 1903 corresponding to the information desired and by clicking on the icon 1904.

FIG. 20 depicts an example of a map illustrating a motorway 2000 with information regarding a point of interest 2001. The user may access this infrastructure by, for example, performing a key word search in the box 301. The user may obtain information about at least one of the characteristic points of the motorway 2001 by clicking on it and on the icon 304. The information may relate to its location, notably its geodesic coordinates, the location accuracy, the date of update, a photograph of the motorway 2002. The user may modify at least one of these items of information by clicking on the icon 2005. The user may download this information by checking the check box 2003 corresponding to the desired information and by clicking on the icon 2004.

Of course, the invention is not restricted to the examples described. Notably the hardware and software architecture of the platform may be modified.

1. Computer platform for pooling and viewing digital data on a planet or sub-planet scale, which platform lists georeferenced data used for the representation of heterogeneous objects originating from various sources, including objects derived from scans and objects derived from at least one computer assisted drawing software package, metadata logged in at least one database being associated with at least some of the georeferenced data, these metadata comprising at least one item of information relating to the accuracy with which the position of these georeferenced data in at least one frame of reference is known,
the platform comprising:
a data storage layer allowing the storage of data transmitted by users to the platform,
a data management layer allowing control of access to the platform, the indexing of data, the exporting or importing of data,
a macrofunctions layer of macrofunctions supplied to the users,
an interface layer for interfacing with the users.

2. Platform according to claim 1, at least some of the data logged in the database relating to the subsoil and/or to objects incorporated in the ground.

3. Platform according to claim 1, the data logged in the database comprising panoramic images, orthophotographs, images of the elevation type, and/or data in the form of point clouds.

4. Platform according to claim 1, the scan objects being modeled using lasergrametry, photogrametry or interferometry techniques.

5. Platform according to claim 1, comprising geological data of the subsoil having a geolocation accuracy, in a frame of reference, of better than 1 m and/or being designed to allow such data to be logged on the platform.

6. Platform according to claim 1, being designed to offer all or some of the following functionalities:
of allowing a plurality of users to connect remotely thereto via terminals and to allow access to certain data to be reserved for a predefined user group or, on the other hand, make these data available to all users,
of allowing a user to select an object in order to access and/or download geolocated data relating thereto, these data being delivered by the platform together with information relating to the accuracy with which the position of these geolocated data in a frame of reference is known,
of allowing a user to display a map on his terminal and to attach documents to an object,
of allowing a user to upload an application to make it available to other users of the platform and allow them to run it within the platform in order to process their data,
of allowing a user to share information with other users of the platform and/or of allowing at least two users to collaborate through the platform by exchange of data between these users or via multiple access to information,
of allowing a user to log his data directly and/or to download it from a third-party database,
of allowing a user to create a customized user profile and to interact with the platform via a customized interface,
of allowing a user to log in the platform data relating to various objects at least some of these data being data that is geolocated in a frame of reference,
of allowing a user to augment the data pertaining to objects listed in the platform with metadata chosen from among the name of the work or of the equipment, a characteristic of the work, a date, and so as to allow a user to carry out multicriteria searches on these elements,
of allowing a user having carried out an intervention at a place or on a work and/or item of equipment listed in the platform, to log in this platform a score representative of the reliability of the logged data, a confidence index being calculated from the scores logged by the previous users and supplied to each new user seeking to download these data,
of allowing a user connecting to the platform to interrogate this platform as regards the evolution of at least one parameter pertaining to an object, and to obtain in return, through a prediction tool, a prediction regarding the future of said parameter, the prediction tool having been generated by processing data logged on the platform using an artificial intelligence engine or using a statistical analysis technique, and/or
of supplying information to make it possible to steer plant or assist an operator using augmented reality.

7. Platform according to claim 1, the geolocated data logged therein comprising data connected with the design, construction and/or operation of a building or of an infrastructure on the surface or underground.

8. Platform according to claim 1, running an application for analyzing the correlation between at least two 3D models relating to the one same object and according to the correlations detected generating a new 3D model by using data fusion to merge the two models analyzed, and/or running an application to automatically convert a format in which a file has been downloaded into a predefined format and display, on the one same map, information originating from different files, at least one of which has undergone this conversion, and/or receiving meteorological, thermal, traffic and/or seismic data and allowing at least one user to access and/or to download these data.

9. Platform according to claim 1, the geolocated data comprising data corresponding to respective sites, works or items of equipment more than 100 km distant.

10. Platform according to claim 1, the data storage layer comprising:
a data lake,
a relational database comprising all the structured information of the platform, and the metadata allowing access to the information stored in the data layer and allowing management of rights of access to the facts,
a database, for storing unstructured data,
a storage space, to receive files associated with the facts, and
a document management space, providing the users with an information sharing and exchanging space.

11. Platform according to claim 1, the data management layer being accessible to the macrofunctions layer through an API and/or being configured to offer all or some of the following functionalities:
a multicriteria access service for searching on and providing read-access to the facts,
a service controlling access to the facts, making it possible to guarantee the security of the data,
a service for extracting and exporting facts, to various formats,
an access accounting service to measure the level of usage of the APIs and various types of data,
an import service that also includes block or individual updating, making it possible to augment, translate the format, filter, hierarchize, validate and clean the data during import,
a data transformation service configured to harmonize the indexing of the data, to correlate data that meets certain criteria in order to clean and/or augment certain external data.

12. Platform according to claim 1, the macrofunctions layer being designed to perform all or some of the following functions:
of creating and managing a user account on the platform,
of browsing the facts logged on the platform using a browser,
of accessing platform data from applications external to the platform, and
of managing the data sources.

13. Platform according to claim 12, the browser being designed to:
allow the viewing of a map with a 2D, 2.5D or 3D rendition according to the level of zoom, the browser being designed to allow the display of a catalog of available map backgrounds and the selection of one or more map backgrounds, and to display at least some of the information of the selected map backgrounds in overlay and make it possible to change the order in which the map backgrounds are overlaid within the map displayed and/or implement action or information markers on a map,
allow a selection frame deployed over a map to be displayed and/or being designed to calculate the distance between two points, the projected distance, the area of a selected zone, the projected area, with the possibility to select the color and/or the transparency of the selected zone and how it appears according to the level of zoom,
allow creation of a bar graph and longitudinal sections representing a stratigram of the subsoil,
allow an attribute to be assigned to an object featured on the map and this attribute displayed in a predefined format,
allow a group of objects to be created and shown as such on the map,
allow parameters connected with the objects appearing on the map to be displayed automatically,
allow a search by coordinates in a frame of reference,
offer tools for measuring a distance on the map, a surface area, for editing an altimetric profile, for calculating an isochron, for measuring an azimuth and/or for simulating the lighting of a site according to the time of day, and/or
allow a search profile to be defined and memorized, making it possible for the predefined search fields associated with a user identifier to be displayed automatically.

14. Platform according to claim 1, the user interface layer comprising at least one of the following:
an interface of web type,
an interface of mobile app type,
an interface of API gateway type,
a blockchain interface.

15. Method for logging data relating to a site or work, comprising the step consisting in performing at least one geolocated optical acquisition of the site or of the work, and in uploading this acquisition, together with information georeferencing the acquisition in a frame of reference, into the computer platform according to claim 1.

16. Method according to claim 15, comprising the step consisting in also uploading into the computer platform information relating to the accuracy with which the georeferencing information is known.

17. Method according to claim 15, comprising a processing of the acquisition by an object recognition tool available on the computer platform with data relating to the site or to the work being augmented with metadata derived from this processing.

18. Method for determining at least one model predicting the occurrence of an event, comprising a statistical and/or artificial-intelligence treatment of data logged on the platform according to claim 1 in order to find a connection between certain input factors and the event and to generate said predictive model.

19. Site monitoring method comprising the step consisting in equipping a zone with at least one site monitoring geolocated instrument and in downloading into the computer platform according to claim 1, data derived from this instrument.

20. Method for performing an intervention, comprising the steps consisting in:
connecting to the platform according to claim 1, and downloading geolocated data relating to a place and/or work involved in the intervention,
performing the intervention on the basis of these data, and publishing an intervention dossier regarding the site work online on the platform.

21. Method according to claim 20, the intervention comprising the digging of an excavation and/or the sinking of a bore hole.

22. Method according to claim 20, the intervention being carried out according to the accuracy with which the position of the geolocated data in a frame of reference is known, as supplied by the platform.

23. Method for constructing a works comprising the steps consisting in:
downloading and/or viewing geolocated data relating to the surroundings of the work from the platform according to claim 1,
carrying out the work with consideration to the downloaded data and their updates making it possible to limit rework, and performing the work in a coordinated manner with the information relating to infrastructure elements of a geographic nature being shared between the various participants and/or with comments, attached documents and/or reviews pertaining to these elements being shared in real time.

24. Method according to claim 23, in which design data pertaining to the work, data relating to site progress, data relating to the condition of the ground or of the subsoil, data relating to the work as constructed and/or data relating to the maintenance or operation thereof are logged in the platform.
